(19) United States
(12) Patent Application Publication
(10) Pub. No.: US 2009/0091563 A1
(43) Pub. Date: Apr. 9, 2009

(54) CHARACTER ANIMATION FRAMEWORK

(75) Inventors: Frank Viz, West Vancouver (CA); Geoff Harrower, Burnaby (CA); Brian Plank, Delta (CA); Jason Osipa, San Francisco, CA (US); Brian Keane, San Francisco, CA (US); Toru Tokuhara, Vancouver (CA); Simon Sherr, Burnaby (CA); David Bolio, (US)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronics Arts Inc., Redwood City, CA (US)

(21) Appl. No.: 11/744,746

(22) Filed: May 4, 2007

Related U.S. Application Data
(60) Provisional application No. 60/746,623, filed on May 5, 2006.

(51) Int. Cl. G06T 17/00

(52) U.S. Cl. 345/419

(57) ABSTRACT

An extensible character animation framework is provided that enables video game design teams to develop reusable animation controllers that are customizable for specific applications. According to embodiments, the animation framework enables animators to construct complex animations by creating hierarchies of animation controllers, and the complex animation is created by blending the animation outputs of each of the animation controllers in the hierarchy. The extensible animation framework also provides animators with the ability to customize various attributes of a character being animated and to view the changes to the animation in real-time in order to provide immediate feedback to the animators without requiring that the animators manually rebuild the animation data each time that the animators make a chance to the animation data.

### CROSS-REFERENCES TO RELATED APPLICATIONS

This application is a claims the benefit of U.S. Provisional No. 60/746,623, filed on May 5, 2006, the full disclosure of which is incorporated herein by reference.

### BACKGROUND OF THE INVENTION

Electronic game development is a labor intensive process that includes the creation, preparation and integration of animation assets into a video game software program. The development of process typically requires an entire team of people, including animators and software engineers.

Animators typically create animations to be used in video games on computers, and a number of software tools are available for creating computer animations. However, even with the use of computers and currently available software animation tools, the animation process is still very labor-intensive. Furthermore, as a result of using various tools to develop character animations for different games, the animation assets created by animators for one game may not be suitable for reuse in another game. For example, humanoid characters developed for a sports simulation game using a first modeling and animation tool may have been suitable for reuse in a later game being developed, such as a role playing game, where humanoid characters interact with other humanoid and non-humanoid characters in a simulated world.

However, unless the animation data created using the first modeling and animation tool is compatible with the animation tools that animators are using to create the characters and environment in the role playing game, the animation assets created for the sports simulation game will not be able to be reused to speed the development of characters for the role playing game. The result is that game publishers and developers invest a lot of time developing character animations for each game under development rather than simply being able to reuse existing animation to facilitate faster game development.

The problems facing animators attempting to reuse existing animation assets are compounded by difficulties presented by the need to rebuild animation assets after manipulating the animation data. One technique used by animators to create animations is the use of key framing. In key framing, an animator creates an animation sequence by stringing together a series of animation clips. The animator will often need to review video sequences of animation frame by frame in order to determine a location in a video sequence for transition from one animation clip to another animation clip where the transition between the two clips will appear smooth and will not be noticeable to a viewer. The process of assembling an animation sequence from a series of animation clips can be extremely time consuming, because animators must over review an animation clip both backwards and forwards many times in order to locate an appropriate transition point.

When an animator wants to make a change to an animation sequence, the animator will often require the assistance of a software engineer to rebuild the data associated with an animation asset each time that the animator makes changes to animation sequence. As a result, significant delays can be introduced in the production process. The animator's work is interrupted while the software engineer rebuilds the data set, and the software engineer's work on other software-related development for the vide game is disrupted while the software engineer implements the changes to the data introduced by the animator.

Accordingly a system that reduces the amount of time that software engineers must be involved in the animation process and that enables animators to make changes to animation data quickly and efficiently is desired. An improved character animation framework is needed that that can be more easily integrated into the video game development pipeline and that allows for the creation of standardized animation data assets that can be reused in subsequent game development.

### BRIEF SUMMARY OF THE INVENTION

An extensible character animation framework is provided that enables video game design teams to develop reusable animation controllers that are customizable for specific applications. According to embodiments, the animation framework enables animators to construct complex animations by creating hierarchies of animation controllers. According to some embodiments, complex animations are created by blending the animation outputs of each of a plurality of animation controllers in the hierarchy. The extensible animation framework also provides animators with the ability to customize various attributes of an animated character and to view and updated rendering of animated character in real-time. The animator is thus provided with immediate visual feedback as to the impact of the animator's changes to the animation data without requiring the animator to perform the often cumbersome steps of rebuilding the animation asset manually. As a result, animators using the extensible character animation framework provided herein should not require the assistance of a software engineer to recompile an animation asset after the animator has updated the animation data.

The extensible character animation framework provided herein also promotes the reuse of animation assets by enabling animators to load existing animation assets created by various techniques into the framework, to customize the animation assets through the use of one or more animation controllers, and to store the updated animation data in a persistent store for possible reuse in subsequent animation projects.

A character animation framework is configured for creating reusable three-dimensional character animations is provided. The character animation framework comprises logic for receiving a set of animation data. The animation data includes high-level control parameters for animating a three-dimensional character in simulated three-dimensional environment. The character animation framework further comprises logic for selecting at least one of a plurality of animation controllers. The character animation framework also comprises logic for modifying the animation data to create a set of modified animation data using the at least one of the plurality of animation controllers selected. The character animation framework also include logic for outputting the modified animation data to a rendering engine configured to generate a series of images of an animated scene using the set of modified animation data.

Other features and advantages of the invention will be apparent in view of the following detailed description and preferred embodiments.

### BRIEF DESCRIPTION OF THE DRAWINGS

FIG. 1 is an illustration of an animation computer system for executing a character animation framework according to an embodiment.

FIG. 2 is an illustration of an embodiment of a computer system for use in an animation computer system according to embodiments of the present invention.

FIG. 3 is a block diagram illustrating animation data flow according to an embodiment.

FIG. 4 is a block diagram illustrating components of an animation framework according to an embodiment of the present invention.

FIG. 5 is a flowchart illustrating steps in a process for executing various stages of an animation flow according to the embodiment described in FIG. 3.

FIG. 6 is a block diagram illustrating a high-level architecture of an animation framework according to an embodiment of the present invention.

FIG. 7 is a diagram illustrating the architecture of a plug-in structure according to an embodiment.

FIG. 8A is an illustration of an animation controller hierarchy according to an embodiment.

FIG. 8B is another illustration of an animation controller hierarchy according to an embodiment.

FIG. 8C is yet another illustration of an animation controller hierarchy according to an embodiment.

FIG. 9A is an illustration of an animation controller hierarchy and an EvalNode hierarchy according to an embodiment.

FIG. 9B is another illustration of an animation controller hierarchy and an EvalNode hierarchy according to an embodiment.

FIG. 9C is yet another illustration of an animation controller hierarchy and an EvalNode hierarchy according to an embodiment.

FIG. 10A is an illustration of an animation controller optimizing an EvalNode tree according to an embodiment.

FIG. 10B is another illustration of an animation controller optimizing an EvalNode tree according to an embodiment.

FIG. 11 is an illustration of a user interface for a character animation framework according to an embodiment.

FIG. 12 is another illustration of a user interface for a character animation framework according to an embodiment.

FIG. 13 is yet another illustration of a user interface for a character animation framework according to an embodiment.

FIG. 14 is an illustration of a procedural awareness user interface displaying a character reacting tracking and reacting to an object and expressing emotion according to an embodiment.

FIG. 15 is a diagram illustrating a user interface for a procedural awareness component implemented in a character animation framework according to an embodiment.

### DETAILED DESCRIPTION OF THE INVENTION

An extensible character animation framework is provided that enables video game design teams to develop reusable animation controllers that are customizable for specific applications. The character animation framework may also advantageously save a significant amount of development time during the design of subsequent video games by enabling animators to modify existing animations in real-time to optimize the existing animations for use in the subsequent video games.

According to embodiments, the animation framework advantageously enables animators to construct complex animations by creating hierarchies of animation controllers and blending the animation outputs of each of the animation controllers in the hierarchy. The extensible animation framework also provides animators with the ability to customize various attributes of an animated character and to view and updated rendering of animated character in real-time without requiring the animators to manually recompile the animation data each time the animator makes a change to the data.

### Computer Animation System Including Character Animation Framework

FIG. 1 illustrates an animation computer system 110 for executing a character animation framework according to an embodiment. System is shown including one or more media 112, a computer system 114, and a display 116.

One or more media 112 can include one or more application components of a character animation framework, such as software modules, plug-ins, and/or other executable content comprising the animation framework. Furthermore, media 112 may include animation data for use by the animation framework, such as configuration data, animation clips, images, sounds, rigs, textures, rigs, character attitudes, and/or other data used and/or created by the animation framework. The animation data may have been previously created by the animation framework and/or may have been created by one or more software applications external to the animation framework and/or external to animation computer system 110.

Media 112 may comprise any type of persistent computer memory and may comprise either removable media, such as compact disk read-only memories (CD-ROMs), digital versatile disks (DVDs) and/or flash drives, and/or non-removable memory, such as magnetic and/or optical disk drives and/or flash memory. Furthermore, media 112 may comprise one or more network storage devices external to computer system 114 and/or one or more storage devices internal to computer system 114. According to some embodiments, a removable media is inserted in, coupled to, or in communication with computer system 114 so that computer system 114 may read all or part of an application program code and/or related animation data found on media 112 of the animation framework.

Computer system 114 is a computing device that includes a processor, such as a CPU, and data storage combined or in separate elements. Computer system 114 may be connected to a network that allows computer system 114 to create and/or access additional animation data that is not stored on media 112. The computer animation system 110 should be understood to include software code for one or more software applications that computer system 114 uses to provide a character animation framework for a user to create and/or modify animation data. The one or more software applications might comprise software code that informs computer system 114 of processor instructions to execute, but might also include data used in creating character animations, such as data relating to animation clips, images and other data structures created by animators and/or software developers for producing computer animation. A user interacts with the character animation framework and computer system 114 through user input/output (I/O) devices.

Display 116 is shown as separate hardware from computer system 114, but it should be understood that display 116 could be an integral part of computer system 114. It should also be understood that media 112 could be an integral part of computer system 114. Media 112 might also be remote from computer system 114, such as where media 112 is network storage that computer system 114 accesses over a network connection to execute code stored on media 112 or to download code from media 112.

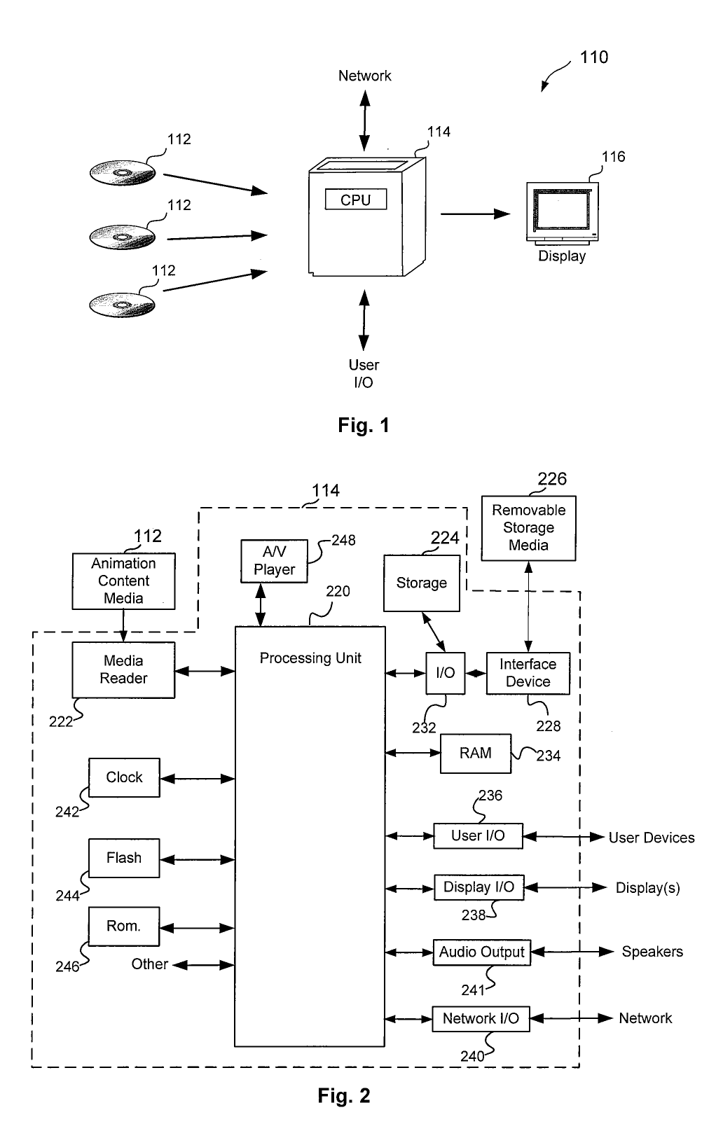

FIG. 2 illustrates an embodiment of computer system 114 according to embodiments of the present invention. It should be understood that other variations of computer system 114 may be substituted for the examples explicitly presented herein and while the hardware might be essential to allow user interaction with the animation framework, it is not essential to an implementation of the invention even if it is essential to the operation of it.

As shown, computer system 114 includes a processing unit 220 that interacts with other components of computer system 114 and also interacts with external components to computer system 114. A media reader 222 is included that communicates with media 112. Media reader 222 may be a CD-ROM or DVD unit that reads a CD-ROM, DVD, or any other reader that can receive and read data from media 112.

Computer system 114 also includes various components for enabling input/output, such as an I/O 232, a user I/O 236, a display I/O 238, and a network I/O 240. I/O 232 interacts with a storage 224 and, through an interface device 228, removable storage media 226 in order to provide storage for computer system 114. Processing unit 220 communicates through I/O 232 to store data, such as animation data and any data files. In addition to storage 224 and removable storage media 226, computer system 114 includes random access memory (RAM) 234. RAM 234 may be used for data that is accessed frequently, such as character attribute variables when an animated character is being viewed and/or modified using the animation framework.

User I/O 236 is used to send and receive commands between processing unit 220 and user devices, such as a keyboard, mouse, tablet and/or other input device. Display I/O 238 provides input/output functions that are used to display images from the character animation framework. Network I/O 240 is used for input/output functions for a network. Network I/O 240 may be used if animation data and/or character animation framework software modules, such as plug-ins, are being accessed over the Internet or across a network. Audio output 241 comprises software and/or hardware to interface to speakers (such as desktop speakers, earphones, etc.). Computer system 114 might also have audio inputs (not shown).

Computer system 114 also includes other features that may be used with an animation framework, such as a clock 242, flash memory 244, read-only memory (ROM) 246, and other components. An audio/video player 248 might be present to play a video sequence, such as a movie or an animation clip. It should be understood that other components may be provided in computer system 114 and that a person skilled in the art will appreciate other variations of computer system 114.

### Character Animation Framework

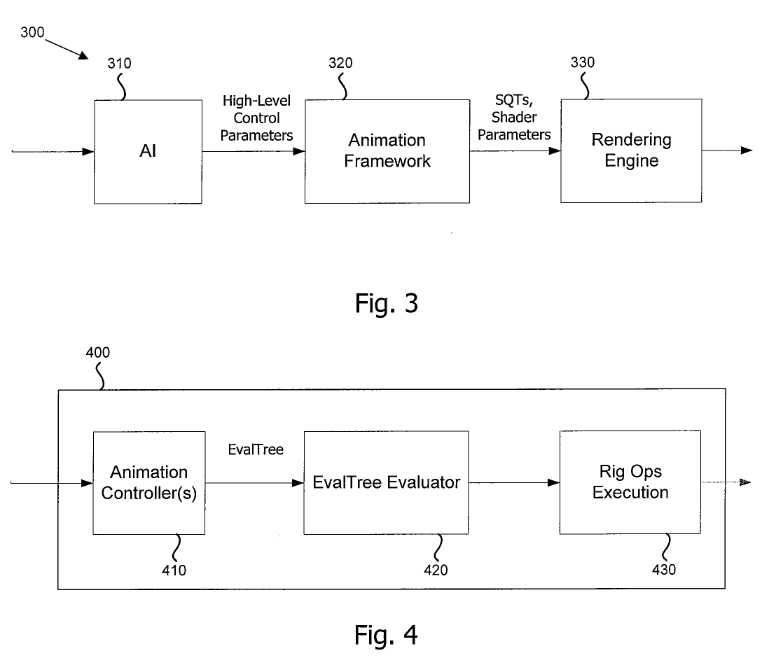

FIG. 3 is a block diagram illustrating animation data flow according to an embodiment. The animation data flow comprises a artificial intelligence (AI) module 310, an animation framework 320, and a rendering engine 330. AI module 310 provides high-level control parameters to animation framework 320. The high level control parameters describe the motion of an animated character. High level control parameters may be generated using various techniques known to the art such as keyframe animation and/or motion capture (“mocap”) animation techniques. In keyframe animation, an animator creates target poses for a character, and intervening frames of animation are generated to transition the character being animated from one pose to the next pose. In mocap animation, various motion capture techniques are used to capture the motion of a live-action performer and the captured motion data is used to control the movements of a simulated character.

Character animation framework 320 enables animators to modify the high-level animation data receive from AI module 310. For example, character animation framework 320 may be used to modify motion capture data of a person running to customize the data for use with a simulated character running in a sports simulation game.

Embodiments of animation framework 320 may include a plurality of animation controllers configured to enable an animator to modify the character animation data. The animation output from the plurality of animation controllers may then be blended together in some embodiments to create a blended animation output that comprises attributes of the animation output of the each of the plurality of animation controllers. Accordingly, an animator may create complex high-level behaviors in an animation by combining the outputs of multiple animation controllers providing primitive behaviors. Furthermore, according to yet other embodiments, animation controllers may be assigned a weighted values and the influence that each animation controller exerts on the final output is determined based upon the weights assigned to each animation controller.

Character animation framework 320 outputs the modified animation data to rendering engine 330. Rendering engine 330 generates a series of images of an animated scene using the modified animation data to produce animation clips that can then be integrated into a video game being developed. Furthermore, according to an embodiment, rendering engine 330 may also output a dynamically updated rendering of an animated character as an animator makes changes to various attributes associated with the animated character, in order to provide the animator with immediate visual feedback of the effects of the changes to the animation data.

FIG. 4 is a block diagram illustrating components of an animation framework 400 according to an embodiment. Animation framework 400 includes animation controller 410, EvalTree evaluator 420, and Rig Ops execution module 430. According to some embodiments, animation framework may include a plurality of animation controllers 410.

Animation controller 410 creates evaluation trees (“EvalTrees”). EvalTrees are comprised of hierarchies of evaluation nodes (“EvalNodes”). According to some embodiments, animation controller 410 may have a plurality of child animation controllers, and animation controller 410 may create a blend node (“BlendNode”) that blends the resulting EvalNodes created by each of the plurality of child animation controllers.

According to some embodiments, a parent animation controller does not need to know the type of animation controller of each child animation controller. Instead, the parent animation controller merely needs to be able to read the EvalNodes received from each child animation controller and process the EvalNodes accordingly. EvalTrees and EvalNodes are described in greater detail below.

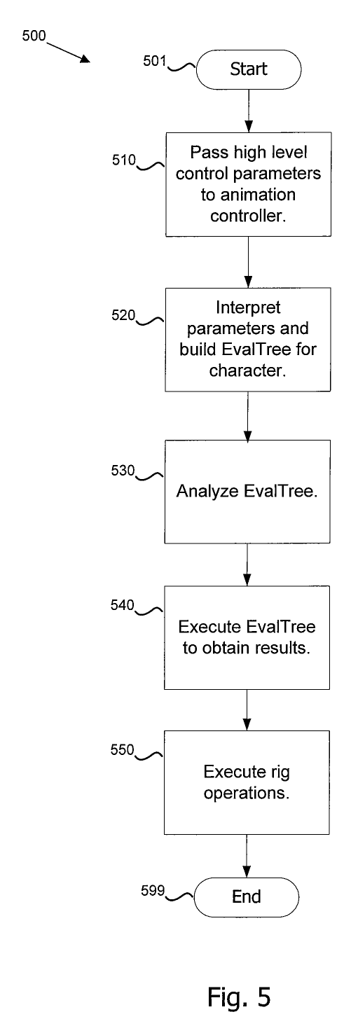

FIG. 5 is a flowchart illustrating process 500 for executing an animation flow according to an embodiment. Process 500 begins with step 501 and proceeds to step 510. In step 510, an AI module, such as AI module 310, passes high level control parameters for a character animation to an animation controller, such as animation controller 410 described above. According to some embodiments, a plurality of animation controllers may be included in an animation flow. Furthermore, according yet other embodiments, the high level control parameters may be passed to a parent animation controller having one or more child animation controllers and the parent animation controller passes the high level control parameters to each of the one or more child animation controllers.

In step 520, the animation controller interprets the set of high-level control parameters received in step 510 and builds an EvalTree for the character to be animated. According to an embodiment, a high-level animation controller may be implemented by combining the animation output of other more primitive animation controllers. For example, a parent animation controller may blend the animation output of a plurality of child animation controllers to produce complex animated behavior from a plurality of less complex animated behaviors produced by the child animation controllers. According to an embodiment, the high-level animation controller builds an EvalTree by assembling the EvalTrees of other source animation controllers.

In step 530, an EvalTree evaluator, such as EvalTree evaluator 420, analyzes the EvalTree and generates a set of results by executing the operations specified in the EvalNodes of the EvalTree. Each EvalNode specifies a type of operation to perform on a pose or a series of poses. EvalNodes are similar to mathematical operators, except that EvalNodes may have parameters applied to them when the EvalNodes are instantiated. Examples of several types of EvalNodes are described in greater detail below.

In step 540, a rig operation (“RigOp”) is executed on the EvalTree. According to some embodiments, the rig operation is executed as a pull model. Rigs are often used in character animations. A typical rig may comprise a collection of character components, such as a skeletal structure and a mesh to be skinned over the skeletal structure. A rig may also comprise a set of animation controls that enable an animator to move the various components of the character in order to create motion in an animation.

A typical rig comprises a skeletal structure for a character and includes a plurality of user-defined degrees of freedom (“DOF”). A DOF may be used to control one or more properties associated with the components of the character. For example, a DOF may be used to control the angle of rotation of a neck joint of a character. DOF are not, however, limited to representing skeletal data associated with the character. DOFs may include additional properties such as shader parameters that are used when rendering the animated character.

According to some embodiments, DOFs may be of various data types. For example, some DOFs may be basic data types such as floating point number (“float”) or an integer (“int”), while other DOFs may include compound data types, such as a Vector3, which is a data structure configured for storing 3-D dimensional coordinate data including an X, Y, and Z coordinate.

Rigs typically store semantic data that identifies each of the various components of a character, such as bone names, DOF names, memory offset, and/or other rig component identifiers. Rigs, however, typically are not used to store specific data value associated with each component. Accordingly, a separate set of animation data is typically used to define specific data values, such as positional data, for each of the rig components. According to some embodiments, specific data values related to a rig are stored in rig pose data structures, which are described in greater detail below.

A character may also comprise more than one rig. For example, the arms, legs, torso and head of a character may be included in one rig, the face of the character may be included in another rig, and the hands of the character may be included in yet another rig. Embodiments of the animation framework enable an animator to create a character using multiple rigs and to blend the animation output of the multiple rigs together without causing overlap of the components of the character.

Rig poses (“RigPose”) are data structures used to store raw data values such as positional data and other information about a rig. For example, a RigPose may include raw data values for a rig representing the facial features of a character, and the data may comprise positional data for each of the facial features that represent a particular expression such as a smile or a frown. A RigPose is generated by an animation controller and the RigPose is stored in the EvalNode output by the animation controller. The raw data values stored in the RigPose are used by one or more rig operations (described below) that perform post-processing on the rig.

Rig operations (“RigOps”) are operations that read in the one or more DOFs from a rig, modify the DOFs to place the animated character is a particular pose, and update the rig with the modified DOFs. According to an embodiment, the rig operations are stored in a rig operations stack, and the rig operations stack is stored at a top-level node of the rig structure.

According to an embodiment, the animation framework includes four standard rig operations: (1) pose to local; (2) local to global; (3) global to local; and (4) delta trajectory.

The pose to local rig operation converts pose information, such as scale, translation, and rotation, to a set of local bone-space coordinates.

The local to global rig operation converts local bone-space coordinates to a set of global-space coordinates. For example, the local to global rig operation may iterate through each joint in a skeleton structure associated with a rig and convert the coordinates from local bone-space to global-space coordinates by multiplying each of the local bone-space coordinates by a conversion factor to convert the local bone-space coordinates to global-space coordinates.

The global to local rig operation is the inverse of the global to local rig operation. The global to local rig operation converts from global-space coordinates to local bone-space coordinates by multiplying global-space matrices by an inverse conversion factor.

The delta trajectory rig operation determines a new position for a bone by adding a delta value representing a translation and rotation to special “trajectory bones.” The delta translation and rotation values are added to the current attributes of the trajectory bone to determine a new position for the bone rather, unlike typical bones where new positional information for the bone is simply set directly.

Rig operations are written to the rig operations stack and executed on the rig in step 430 of character animation framework 400.

According to an embodiment, rig operations are executed as a pull model where the rig operations associated with a rig are only executed when requested. Requests to execute rig operations may originate from the character animation framework according to some embodiments, or in other embodiments requests to execute rig operations may originate from outside of the animation framework, such as from a rendering software program and/or other external software program. In embodiments where the rig operations are stored in a rig operations stack, the rig operations remain in the rig operations stack until a request to execute the rig operations is received. When a request to execute the rig operations is received, each of the rig operations are popped off of the stack and executed on the rig.

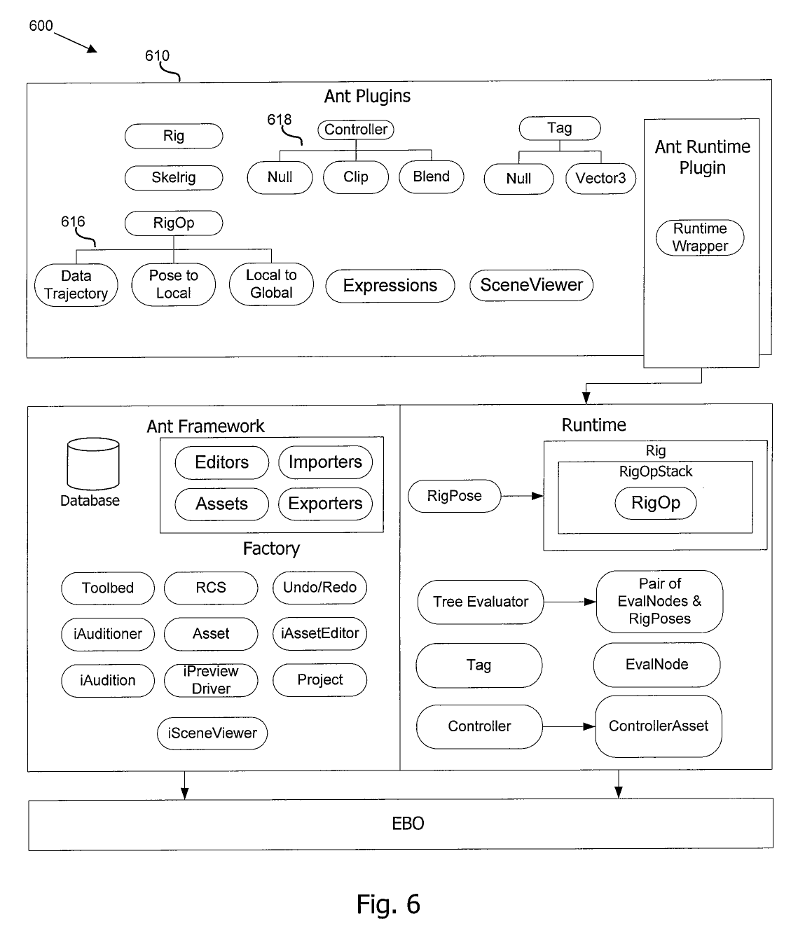

FIG. 6 is a block diagram illustrating a high-level architecture of an animation framework according to an embodiment. Components may include subcomponents. Link 616 and link 618 indicate subcomponents dependent from a component.

Section 610 includes a plurality of plug-ins. Plug-ins are software modules that typically perform a very specific task or function. Plug-in software modules are integrated into the animation framework via a standard interface that enables user to extend the functionality of the system by writing new plug-in modules to perform various functions desired by the user. According to an embodiment, a procedural awareness animation controller may be included in the system to enable an animator to create procedural animations for a character. A procedural awareness controller is described in more detail below.

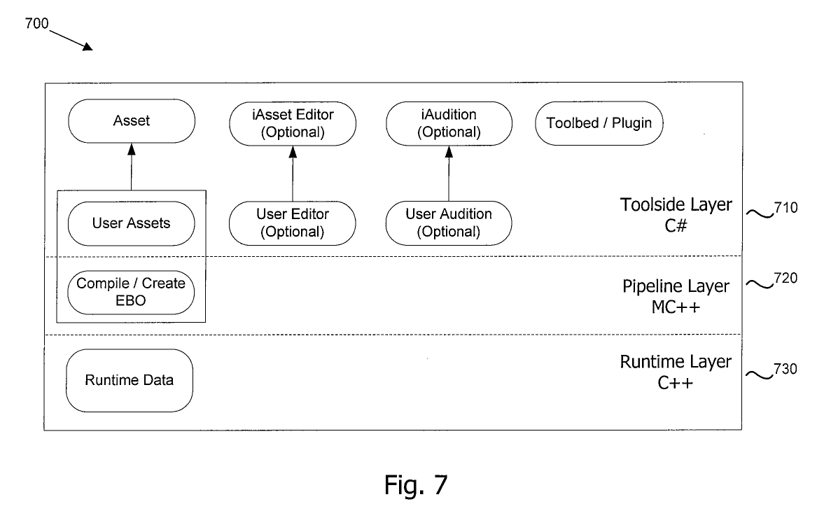

FIG. 7 is a diagram illustrating the architecture of a plug-in structure 700 of an animation framework according to an embodiment. Users of the animation framework can extend the functionality of the framework by writing and integrating plug-ins into the animation framework. For example, according to some embodiments, user may develop and integrate additional animations controllers, rig operations, user interface, viewers, tags, menus, and/or other framework components as plug-ins to the animation framework. Plug-in structure 700 includes three functional layers: toolside layer 710, pipeline layer 720, and runtime layer 730. Toolside layer 710 provides an interface to users of the animation framework that enables the users to access various data and functions of the animation framework. User can then develop and integrate plug-ins that use the data and/or functions of the user framework exposed by toolside layer 710. Pipeline layer 720 links toolside layer 710 to runtime layer 730 and provides functionality to generate runtime data and to generate links to the runtime module of the framework. Runtime layer 730 uses the runtime data generated by pipeline layer 720 when interfacing with the rest of the animation framework.

### EvalNodes

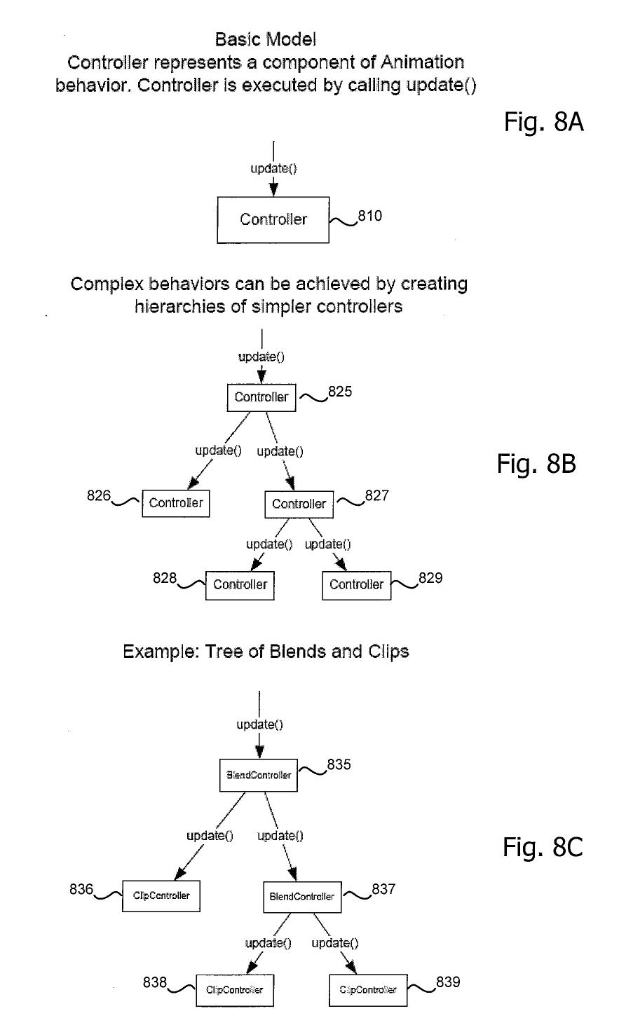

FIGS. 8A, 8B, and 8C are illustrations of an animation controller hierarchy according to an embodiment. FIG. 8A illustrates an animation controller 810. Animation controllers represent a component of animation behavior. Animation controller 810 is executed by calling an update function. FIG. 8B illustrates a hierarchy of animation controllers 820. Complex behaviors can be animated by creating hierarchies of animation controllers that control simpler behaviors. A parent animation controller may have multiple child animation controllers. For example, animation controller 825 has two child animation controllers: animation controller 826 and animation controller 827. Animation controller 827 in turn also has two child animation controllers: animation controller 828 and animation controller 829. A parent animation controller can execute the functionality of a child animation controller by executing the update function of the child animation controller.

FIG. 8C illustrates an animation controller hierarchy where parent animation controllers comprise blend controllers (“BlendControllers”) and child animation controllers comprise animation clip controllers (“ClipControllers”). ClipControllers manage the playback of an animation clip associated with a child animation controller such as child animation controller 838. The animation clip may comprise a set of commands for recreating a motion or set of motions recorded in the clip. A BlendController is another type of animation controller configured to receive animation data output by multiple ClipControllers and to blend the animation data together to produce a blended animation comprising features of each of the animation clips of the ClipControllers. For example, parent animation controller 837 blends the output from child animation controller 838 and child animation controller 839 to output a blended animation output. Parent animation controller 835 then blends the output from child animation controller 836 with the output from parent animation controller 837 to produce a blended animation output.

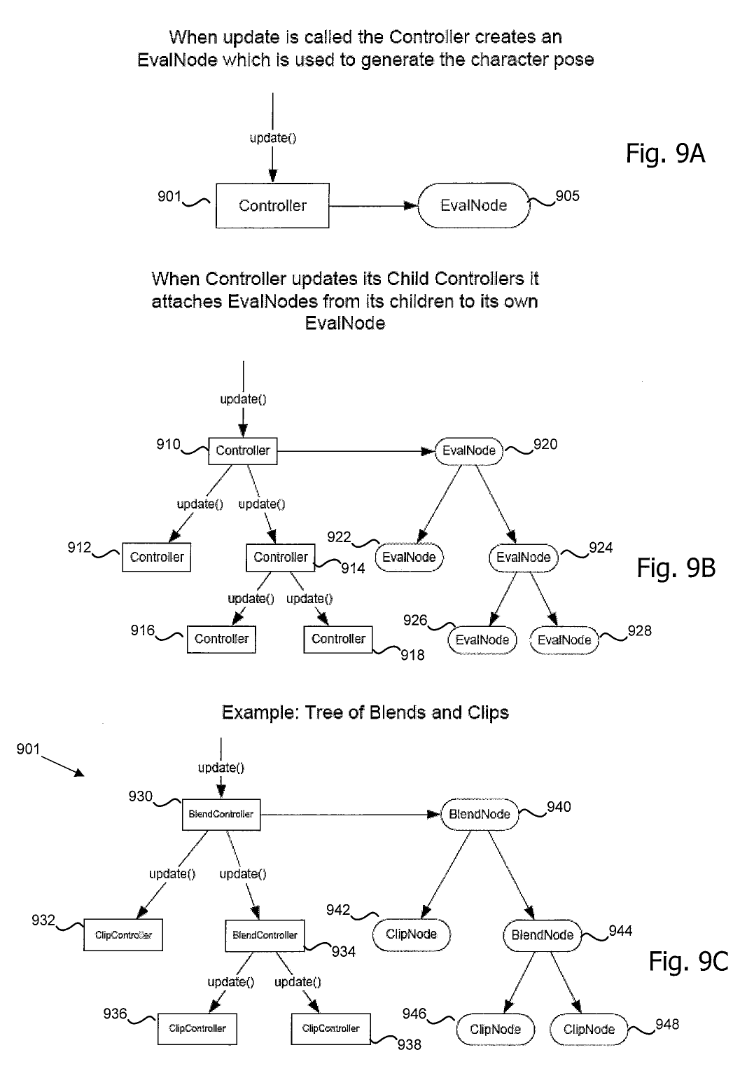

FIGS. 9A and 9B are illustrations of an animation controller hierarchy and an EvalNode hierarchy according to an embodiment. When the update function of an animation controller 901 is called, animation controller 901 creates an EvalNode 905. EvalNodes comprise a set of operations to be executed on a character pose or set of poses.

FIG. 9B illustrates an animation controller hierarchy where a parent animation controller calls the update function of each child node to create an EvalNode tree. Parent animation controller 910 calls the update function of child animation controller 912 and animation controller 914. As a result, child animation controller 912 creates EvalNode 922, which is passed to patent animation controller 910, and parent animation controller 914 calls the update function of child animation controller 916 and child animation controller 918. Child animation controller generates EvalNode 926 and child animation controller 918 generates EvalNode 928. Parent animation controller 914 generates EvalNode 924 and passes EvalNode 924, EvalNode 926, and EvalNode 928 to patent animation controller 910. Parent animation controller 910 receives the EvalNode from each child animation controller and attaches the EvalNodes from the child animation controllers to its own EvalNode 920.

FIG. 9C illustrates an animation controller hierarchy 901 that has an associated with EvalNode tree. Animation controller hierarchy 901 comprises parent animation controller 930 with two children: child animation controller 932 and parent animation controller 934. Parent animation controller 934 includes two child animation controllers: child animation controller 936 and child animation controller 938. Animation controller 930 and animation controller 934 are BlendControllers in the example illustrated in FIG. 9C.

As described above, BlendControllers are a type of animation controller that is configured to blend the animation data received from multiple sources to produce a blended animation output. BlendControllers produce BlendNodes when the update function of the BlendControllers is executed. BlendNodes are a type of EvalNode comprising operations to perform on a pose or set of poses that include blending of multiple animation clips into a single blended animation output. As also describe above, ClipControllers are type of animation controller configured to play back an animation clip. ClipControllers produce a ClipNode when the update function of the ClipControllers is called. ClipNodes also include a set of operations to perform on a pose or set of poses according to the animation clip associated with the ClipNode.

Child animation controller 932, child animation controller 936, and child animation controller 938 are ClipNodes. Accordingly, child animation controller 942 generates ClipNode 942, child animation controller 936 generates ClipNode 946, and child animation controller 938 generates ClipNode 948. Parent animation controller 934 generates BlendNode 944 and passes BlendNode 944, ClipNode 946, and ClipNode 948 to patent animation controller 930. Parent animation controller 930 receives the EvalNodes from each child animation controller and attaches the EvalNodes from the child animation controllers to its own EvalNode (BlendNode 940) to construct an EvalTree.

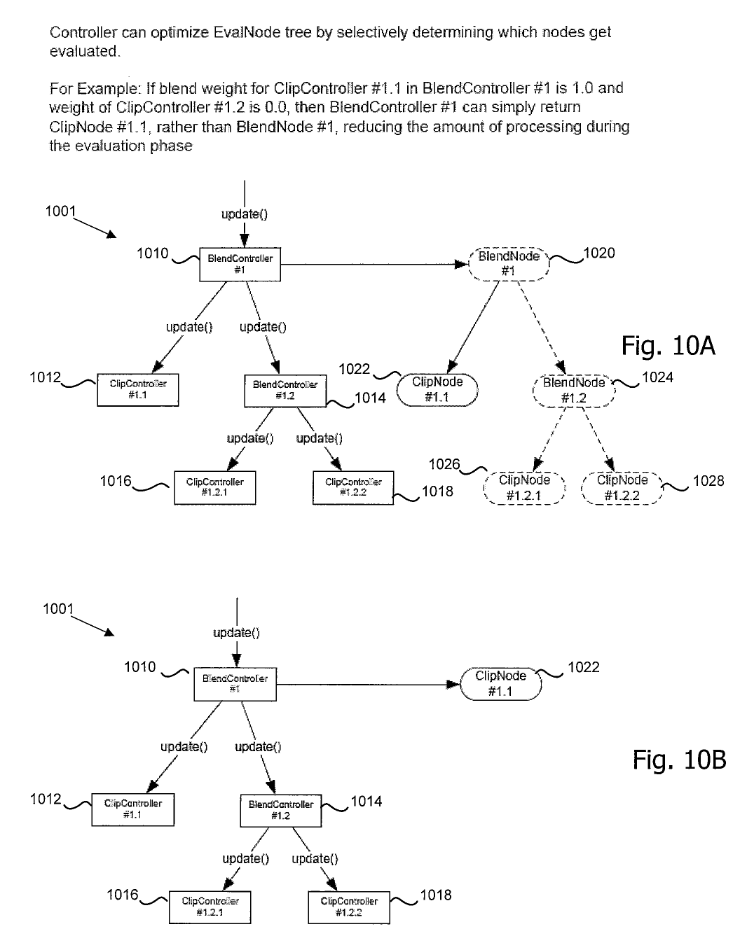

FIGS. 10A and 10B are illustrations of an animation controller optimizing an EvalNode tree according to an embodiment. FIG. 9C illustrates an animation controller hierarchy 9001 with a similar structure as that of the EvalNode tree illustrated in FIG. 10A prior to optimization. FIG. 10A illustrates an animation controller hierarchy 1001 that has an associated with EvalNode tree. Animation controller hierarchy 1001 comprises parent animation controller 1010 with two children: child animation controller 1012 and parent animation controller 1014. Parent animation controller 1014 includes two child animation controllers: child animation controller 1016 and child animation controller 1018. Animation controller 1010 and animation controller 1014 are BlendControllers in the examples illustrated in FIGS. 10A-B. BlendControllers and ClipControllers are described in greater detail above.

An animation controller can optimize an EvalNode tree by selectively determining which nodes get evaluated. According to some embodiments, this selective determination can be accomplished through selection parameters, such as a blend weight, used to determine which nodes should be weighted more heavily than others. For example, if a blend weight of 1.0 is assigned to child animation controller 1012 and a blend weight of 1.2 is assigned to parent animation controller 1014, then the results produced by parent animation controller 1010 will effectively be that of child animation controller 1012, since the results of parent animation controller 1014 are given no weight. Accordingly, the EvalNode tree corresponding to animation node hierarchy 1001 can be trimmed to eliminate the EvalNode 1024 associated with parent animation controller 1014 (which was given zero weight by parent animation controller 1010) as well as eliminate EvalNode 1026 associated with child animation controller 1016 and EvalNode 1028 associated with child animation controller 1018.

FIG. 10B illustrates the animation controller hierarchy having a simplified EvalTree structure 1002. Parent animation controller 1010 points to ClipNode 822. The remaining nodes of the EvalTree were discarded. By simplifying the EvalTree by eliminating nodes in this fashion, the amount of processing that needs to be done during the evaluation phase may be significantly reduced.

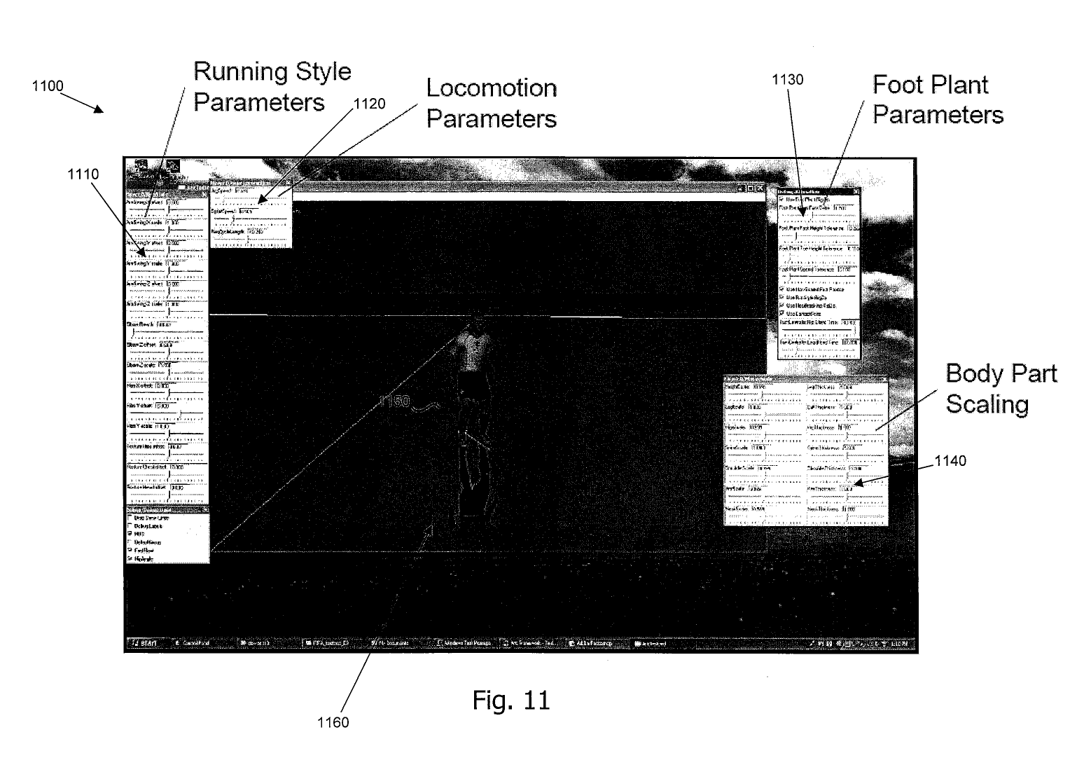

FIGS. 11-13 are illustrations of a user interface of a character animation framework according to an embodiment. FIG. 11 is an illustration of a user interface 1100 of an animation framework configured to enable an animator to edit various character attributes and rebuild animation data automatically. User interface 1100 enables an animator to make changes to an animation, preview the results, and automatically rebuild the animation data without requiring the intervention of a software engineer to rebuild the data.

User interface 1100 includes preview window 1160 and a plurality of user interface panels comprising controls configured to enable an animator to adjust various character attributes associated with an animation. For example, user interface 1100 includes running style parameter editor panel 1110, locomotion parameter editor panel 1120, foot plant parameter editor 1130, and body part scaling editor panel 1140. As the animator makes changes to the various character attributes via the editor panels, the animation data is automatically updated and a preview animation 1150 displayed in preview window 1160 is dynamically updated in real time to provide the animator with immediate visual feedback.

Running style parameters editor panel 1110 enable an animator to configure the running style of a character that determines the appearance of the character as the character runs. Running style parameters editor panel 1110 provides a plurality of slider controls that enable the animator to quickly adjust the running style of the character in order to provide a more realistic character animation. Running style parameters editor panel 1110 may provide the animator with a plurality of running style attributes that the animator may adjust. For example, the animator may adjust how far a character leans forward when the character runs. The animator may make a character run bolt upright or have the character leaning forward at an angle as the character runs. Furthermore, the animator may, in some embodiments, configure the character's arm movements. For example, an animator may configure the character to run while flailing its arms in a customized manner. Running style parameter editor panel 1110, thus enables an animator to create multiple characters with unique running styles and/or to modify a running style of an existing character in order to customize the character for another reuse in another game setting.

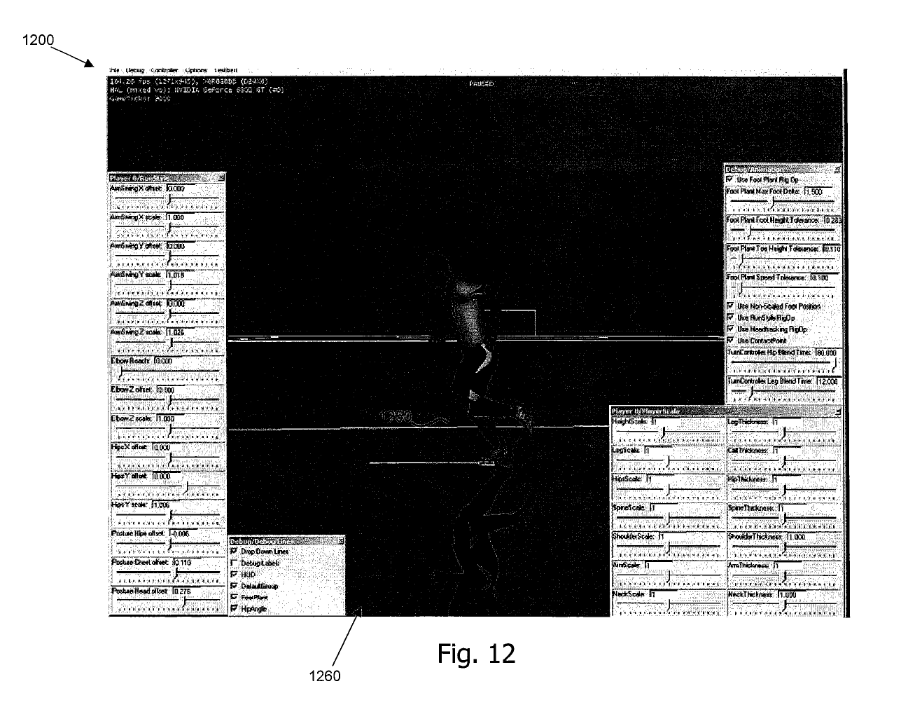

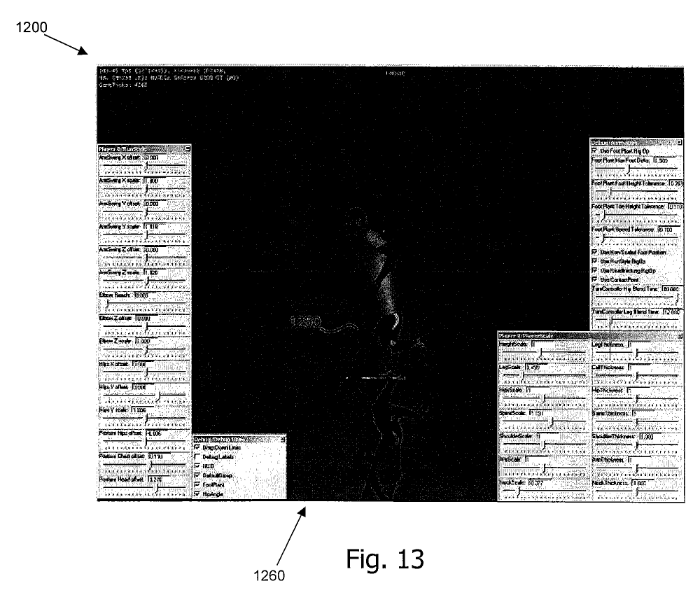

Locomotion parameters editor panel 1120 comprises controls that enable an animator to setup a motion loop for a character, such as a running loop. Locomotion parameters editor panel comprises a plurality of slider buttons that enable the animator to quickly adjust various aspects of a motion loop, such as the speed of motion and the length of the cycle. FIG. 12 illustrates user interface 1260 displaying a motion loop of character 1250 running according to an embodiment, and FIG. 13 illustrates a later frame of the motion loop with character 1250 at different point in the running motion.

Foot plant parameters editor panel 1130 comprises controls that enable an animator to configure how a character's feet impact the ground or another surface. Foot plant parameter editor may include, for example, controls for configuring the surface upon which the character's feet impact. For example, the animator might configure the surface to be springy, such as a rubber surface, or soft, such as a sandy surface, or even slippery, such as an icy surface.

Body part scaling editor panel 1140 comprises a plurality of controls that enables an animator to configure the scaling of various body parts of a character. For example, the animator may adjust a character to have very short legs in comparison to the torso of the character, and in response to this change, animation framework controllers would dynamically update the character animation so that the smaller legs would move faster in order to maintain a currently selected speed. Accordingly, the animator would be able to view effect that a particular change has on the character animation immediately after making the change to the character attributes.

The various editing controls described above are merely exemplary. User interface 1100 may include additional and/or other controls for editing various attributes of an animation. Furthermore, according to some embodiments, plug-in editor modules may be displayed in addition to parameter editor modules included with the animation framework. Furthermore, according to some embodiments, user-defined plug-in modules may also be defined by a user and integrated into user interface 1100. The plurality of editor panels may comprise one or more user interface components that enable an animator to modify attribute parameters, such as slider controls, radio buttons, check boxes, text fields, and/or other user interface components, and the plug-in modules may define their own user interfaces for editing animation data or performing other functions associated with the plug-in modules.

### Procedural Awareness Controllers

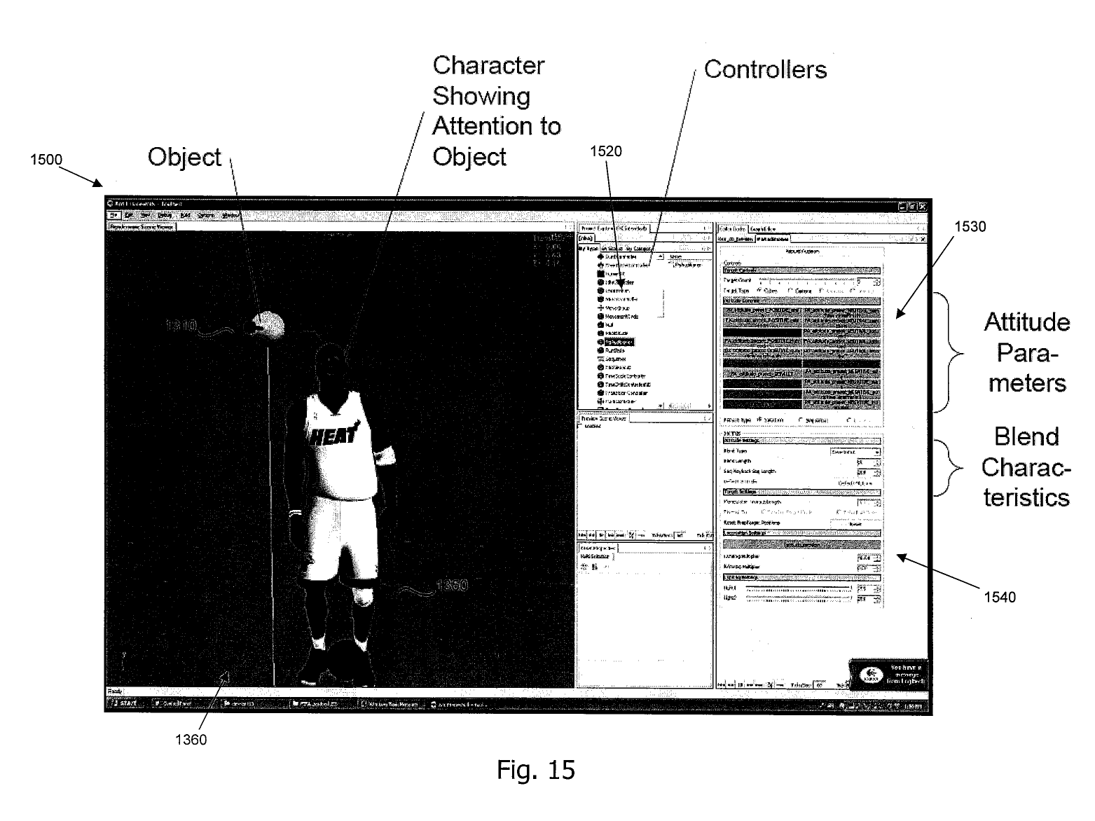

According to an embodiment, the character animation framework may include procedural awareness animation controllers. Procedural Awareness (“PA”) may be implemented through the use of one or more animation controllers such as those described in detail above. Furthermore, according to some embodiments, user-developed procedural awareness animation controllers may be integrated into the character animation framework as plug-ins. FIG. 15, described below, provides an illustration of a user interface for configuring procedural awareness functionality of an animation.

Procedural Awareness (“PA”) provides animated characters with control logic to automatically generate believable and compelling character behavior in real-time. PA driven characters provide an additional sense of realism to animated characters by including real-time systems that enable the characters to dynamically react to various stimuli in a simulated environment. While the concepts embodied by PA are general in nature and can be applied to other systems, for the purposes of the example described herein, PA is implemented through the character animation framework described above. This approach leverages the capabilities and the features of the character animation framework described above. Also, this approach simplifies access to and adoption of PA by game teams who use the character animation framework. Furthermore, PA animation controllers developed for use with the character animation framework described above are reusable and can be customized for use in various animation projects.

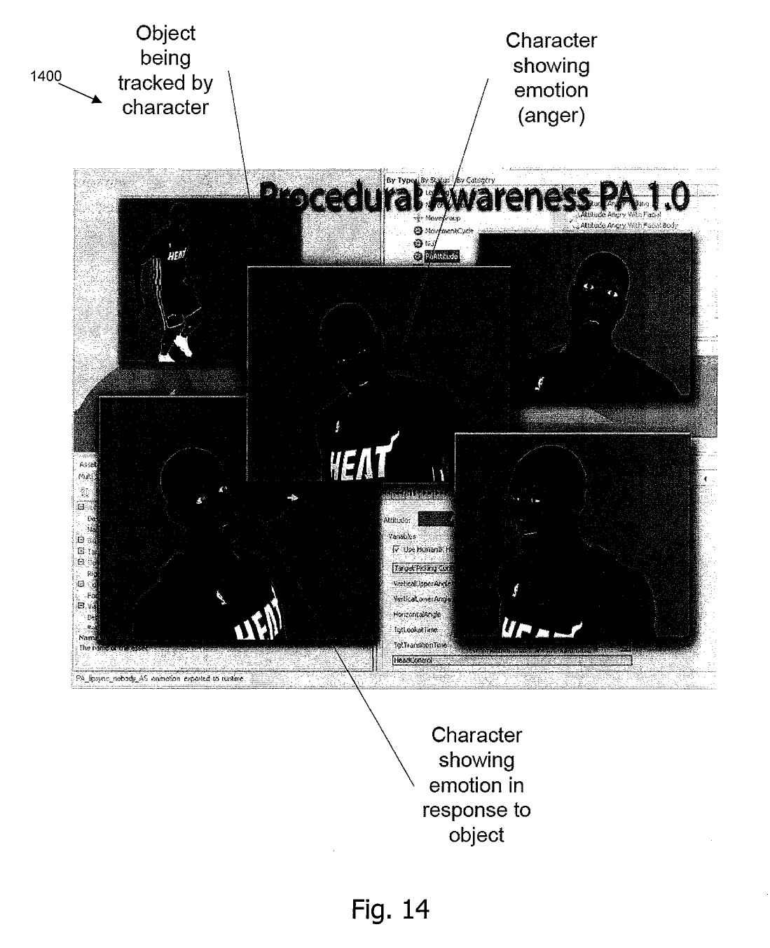

Character behavior generated using PA is not scripted or key framed. Rather the behavior is continuously generated in real-time by an “attitude” module that may be configured to encapsulate a wide range of behaviors. The net result is character behavior that is believable, fast to compute, and non-repetitive. According to an embodiment, character attitudes may be constructed from a plurality of components representing simple movements, such as head tracking, eye movements, facial expressions, and/or other subtle body movements. FIG. 14 is an illustration of a procedural awareness user interface 1400 according to an embodiment. Procedural awareness user interface 1400 displaying a character tracking and reacting to an object and expressing an emotional reaction according to an embodiment.

Attitudes may be named and saved in a library to enable the attitudes to be applied to multiple characters. Furthermore, PA may be combined with other animation techniques such as blended motion capture (“mocap”) or key-frame based animation, such as through the use of the character animation framework described above. PA also provides a consistent framework for sophisticated facial animation techniques, such as lip synchronization and facial mocap. PA thus enables animators to create characters that provide rich, realistic responses by integrating dynamically generated character behavior with traditional predefined animated behavior.

Procedurally aware characters look more lifelike and respond to their surroundings more like a viewer expects live characters to respond. For example, a procedurally aware character may be configured to look around its environment, to blink its eyes, and to include other behavior that would be expected of a live character.

PA characters may also be configured to respond to their surroundings like live characters would be expected to do. For example, a PA character's eyes may follow the progress of a ball (FIG. 14) or the character's eyes may dart back and forth if the character is nervous. A PA character may also be configured to smile if something that the character “likes” is within a certain range of the character. Furthermore, the character can be configured to respond instinctively to certain stimuli. For example, a character can be configured to flinch if there is a loud noise. Moreover, PA characters can be configured to express emotions. For example, a character may be configured to express anger by furrowing its brow and narrowing its eyes in response to various stimuli.

FIG. 15 is a diagram illustrating user interface 1500 for a procedural awareness component implemented in a character animation framework according to an embodiment. An animated character 1520 is shown looking at a target 1510 (the ball floating above and to the left of the character's head). The right-hand side of user interface 1500 comprises a set of user interface components that enable an animator to configure various attributes of procedural awareness animation controllers associated with an animated character. User interface 1500 includes components for selecting animation controllers 1530, for configuring attitudes 1540 parameters, and for configuring blending characteristics 1550.

Procedural awareness attitude parameters may be used to control a variety of attributes of the character. For example, according to some embodiments, attitude parameters (editable via an attitude parameters configuration panel 1540) enable an animator to control character attributes such as: (1) target picking control attributes; (2) head control attributes; (3) spine control attributes; (4) eyelid/eyebrow control attributes; and (5) blink control attributes.

Target picking controls configure how a character responds to active targets that may attract the attention of the character. For example, target picking controls can be used to control the response of character 1520 to a target, such as a target 1510 (a ball). According to some embodiments, a character's field of view can be configured so that the character will only respond to targets that the character could “see” in order to provide an enhanced sense of realism to the character response to a target. Also, according to other embodiments, the amount of time that a character will look at a specific target and how quickly the character's gaze will shift from one target to another may also be configured via the target picking controls.

Head control attributes determine how a character moves its head in response to a target that attracts the attention of the character. In some embodiments, an animator may define head pull and reach parameters for a character that determine how quickly the head follows the direction of the gaze of the character. For example, an animator may configure the head to turn more quickly when animating a character with a nervous attitude but may configure the head to turn more slowly when animating a character that is tired. According to some embodiments, additional head control attributes add offsets to head motion, such as for tipping the head to the side or for pitching the head forward or backward.

Spine control attributes determine a character's body posture and, at least in part, a character's response to targets. For example, according to some embodiments, a spine lag control attribute is included that may be configured by an animator to determine how quickly the character's body turns toward a target.

Eyelid and eyebrow controls determine, at least in part, a character's eye-related movements. For example, according to an embodiment, an animator may configure an eyebrow attribute to arch a character's eyebrows to animate an expression of fright or surprise. Furthermore, according to other embodiments, an animator may configure an eyelid attribute to configure how far a character's eyelids are open. For example, an animator may configure a character's eyelids to be open wide to express surprise or fear, or the animator may configure the character's eyelids to be slitted to express anger or suspicion.

Blink controls determine how a character blinks. For example, according to an embodiment, an animator may configure the duration of a blink, the duration of the time interval between blinks, and/or other attributes.

One skilled in the art will recognize that the examples of attitude parameters provided herein are merely exemplary and that additional character attributes may be controlled via attitude parameters 1540 in order to make the character appear more life-like and to make the character react to the surrounding environment in a believable and realist manner.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A character animation framework configured for creating reusable three-dimensional character animations on a computer, the character animation framework comprising:
logic for receiving a set of animation data, wherein the animation data comprises high-level control parameters for animating a three-dimensional character in a simulated three-dimensional environment;
logic for selecting at least one of a plurality of animation controllers;
logic for modifying the animation data to create a set of modified animation data using the at least one of the plurality of animation controllers; and
logic for outputting the modified animation data to a rendering engine configured to generate a series of images of an animated scene using the set of modified animation data.

2. The character animation framework of claim 1, wherein the character animation framework provides a user interface configured to allow a user to include a plug-in module to extend the functionality of the character animation framework.

3. The character animation framework of claim 2, wherein the plug-in module comprises a user-defined animation controller, and
wherein the logic for modifying the animation data using at least one of a plurality of animation controllers includes:
logic for modifying the animation data using the user-defined animation controller.

4. The character animation framework of claim 1, further comprising:
logic for assembling a high-level animation controller from a subset of the plurality of animation controllers, wherein the high-level animation controller is configured to modify the animation data using each of the subset of the plurality of animation controllers.

5. The character animation framework of claim 4, wherein the subset of the plurality of animation controllers comprising the high-level controller are organized into a hierarchical structure comprising parent animation controllers and child animation controllers.

6. The character animation framework of claim 5, wherein the parent animation controllers are configured to blend the animation output from each child animation controller associated with the parent animation controllers to produce a blended set of animation data.

7. The character animation framework of claim 4, wherein the logic for modifying the animation data further comprises:
logic for creating an evaluation node that corresponds to each of the plurality of animation controllers, wherein the evaluation node is used to generate a pose or a set of poses of the three-dimensional character to be animated.

8. The character animation framework of claim 7, wherein the evaluation nodes are stored in an evaluation tree, wherein the structure of the evaluation tree corresponds to the hierarchical structure of the plurality of animation controllers comprising the high-level controller, and wherein the evaluation tree is used to determine a pose or set of poses for the three-dimensional character to be animated.

9. The character animation framework of claim 8, wherein the character animation framework further comprises:
logic for optimizing the evaluation tree by eliminating evaluation nodes from the evaluation tree that do not satisfy a set of selection parameters.

10. The character animation framework of claim 1, wherein the animation data includes a rig data structure defining a plurality of attributes of the three-dimensional character to be animated.

11. The character animation framework of claim 10, wherein the logic for modifying the animation data to create a set of modified animation data using the at least one of the plurality of animation controllers further comprises:
logic for executing at least one rig operation on the rig data structure.

12. The character animation framework of claim 1, further comprising:
logic to display a user interface comprising:
a plurality of control panels associated with at least a subset of the plurality of animation controllers, wherein the plurality of controls panels are configured to receive user input to modify at least one animation attribute associated with an animation controller; and
a preview panel configured to display a real-time rendered view of the modified animation data, wherein contents of the preview panel dynamically update in response to an update to an animation attribute.

13. The character animation framework of claim 1, further comprising:
logic for storing the modified animation data to a persistent data storage; and
logic for loading a set of animation data to be modified from the persistent storage.

14. The character animation framework of claim 1, wherein at least subset of the plurality of animation controllers are procedural awareness animation controllers configured to generate real-time character animation based upon a pre-defined character attitude.

15. The character animation framework of claim 14, wherein at least subset of the plurality of animation controllers are procedural awareness animation controllers configured to generate real-time character animation based upon a character attitude.

16. The character animation framework of claim 15, wherein the character attitude comprises a plurality of character attributes used to determine at least in part a response of a character to a stimulus in real-time.

17. The character animation framework of claim 16, wherein the character attitude comprises a plurality of character attributes used to determine at least in part the response of a character to a stimulus.

18. A method for creating reusable character animations on a computer using an animation framework, the method comprising:
receiving a set of animation data, wherein the animation data comprises high-level control parameters for animating a three-dimensional character in a simulated three-dimensional environment;
selecting at least one of a plurality of animation controllers;
modifying the animation data to create a set of modified animation data using the at least one of the plurality of animation controllers; and
outputting the modified animation data to a rendering engine configured to generate a series of images comprising an animated scene using the set of modified animation data.

19. The method of claim 18, wherein the step of modifying the animation to create a set of modified animation data further comprises:
receiving a user-defined animation controller; and
modifying the animation data using the user-defined animation controller.

20. The method of claim 18, wherein the step of outputting the modified animation data to a rendering engine configured to generate series of images comprising an animated scene further comprises:
displaying a set of control panels associated with at least a subset of the plurality of animation controllers, wherein the plurality of controls panels are configured to receive user input to modify at least one animation attribute associated with one of the subset of animation controllers, and
displaying in real-time a rendered view of the modified animation data, wherein the rendered view of the modifier animation data dynamically updates to reflect an update to an animation attribute.
